(19) United States
(12) Patent Application Publication
(10) Pub. No.: US 2024/0399806 A1
(43) Pub. Date: Dec. 5, 2024

(54) ADJUSTABLE CONTROL ARM AND BALL JOINT ASSEMBLY

(71) Applicant: RB Distribution, Inc., Colmar, PA (US)

(72) Inventors: Jonathan PETRINA, Glenside, PA (US); Thomas REIFF, Portage, MI (US)

(73) Assignee: RB Distribution, Inc., Colmar, PA (US)

(21) Appl. No.: 18/204,296

(22) Filed: May 31, 2023

(51) Int. Cl. B60G 7/00

(52) U.S. Cl. CPC B60G 7/003; B60G 7/005

(57) ABSTRACT

The disclosure concerns a control arm and a ball assembly that are adjustable relative to each other through a series of slots. The control arm mounts to a vehicle in the usual manner and the position of the ball joint assembly is adjustable by moving the ball joint assembly relative to the control arm and fastened in a desired position.

### BACKGROUND

Control arms are an important component of a vehicle's suspension that allow up and down movement of the suspension while securing the steering knuckles, spindles, and axles to the vehicle and in proper alignment. Control arms have undergone many changes as a result of automotive design and manufacturing technology.

Most modern control arms are adjustable control arms that permit a mechanic to adjust the vertical alignment or camber of the vehicle's wheels. Camber can be negative, the top of the wheel is tilted in, or positive, the top of the wheel is tilted out. Proper adjustment of camber can be major concern in damage repair, racing, and the lowering or lifting a vehicle from a stock position.

When one of these conditions arises with a car or truck, the issue is often addressed by installing adjustable control arms to correct the vehicle's camber. However, many of these solutions require the purchase of a particular control arm that addresses the specific, identified problem. This results in there being multiple replacement control arms, which can create supply and inventory problems.

### SUMMARY

The disclosed control arm embodiments have a control arm and a ball joint carrier that are adjustable relative to each other to provide a greater range of adjustment and installation options. The control arm mounts to a vehicle and receives a ball joint assembly in an adjustable connection formed through coincident slots. The adjustable connection is fixed by a fastener in the coincident fastener slots when a desired position is reached by moving the ball joint assembly relative to the control arm.

### BRIEF DESCRIPTION OF THE DRAWINGS

FIG. 1 is a perspective view of an adjustable control arm and ball joint assembly;

FIG. 2 is an exploded view of the adjustable control arm and ball joint assembly in FIG. 1;

FIG. 3 is a section along the line 3-3 in FIG. 1;

FIG. 4 is a top view of the adjustable control arm and ball joint assembly in FIG. 1;

FIG. 5 is a bottom view of the adjustable control arm and ball joint assembly in FIG. 1;

FIG. 6 is a front view of the adjustable control arm and ball joint assembly in FIG. 1;

FIG. 7 is a rear view of the adjustable control arm and ball joint assembly in FIG. 1;

FIG. 8 is a left side view of the adjustable control arm and ball joint assembly in FIG. 1;

FIG. 9 is a right side view of the adjustable control arm and ball joint assembly in FIG. 1;

FIG. 10 is a perspective view of another adjustable control arm and ball joint assembly;

FIG. 11 is an exploded view of the adjustable control arm and ball joint assembly in FIG. 10;

FIG. 12 is a section along the line 12-12 in FIG. 10;

FIG. 13 is a top view of the adjustable control arm and ball joint assembly in FIG. 10;

FIG. 14 is a bottom view of the adjustable control arm and ball joint assembly in FIG. 10;

FIG. 15 is a front view of the adjustable control arm and ball joint assembly in FIG. 10;

FIG. 16 is a rear view of the adjustable control arm and ball joint assembly in FIG. 10;

FIG. 17 is a left side view of the adjustable control arm and ball joint assembly in FIG. 10;

FIG. 18 is a right side view of the adjustable control arm and ball joint assembly in FIG. 10;

FIG. 19 is a perspective view of another adjustable control arm and ball joint assembly;

FIG. 20 is an exploded view of the adjustable control arm and ball joint assembly in FIG. 19;

FIG. 21 is a top view of the adjustable control arm and ball joint assembly in FIG. 19;

FIG. 22 is a bottom view of the adjustable control arm and ball joint assembly in FIG. 19;

FIG. 23 is a front view of the adjustable control arm and ball joint assembly in FIG. 19;

FIG. 24 is a rear view of the adjustable control arm and ball joint assembly in FIG. 19;

FIG. 25 is a left side view of the adjustable control arm and ball joint assembly in FIG. 19; and,

FIG. 26 is a right side view of the adjustable control arm and ball joint assembly in FIG. 19.

### DETAILED DESCRIPTION

Embodiments of the adjustable control arm and ball joint assembly will be described in detail with reference to the drawings where a same or similar element is identified with the same indicator throughout the description.

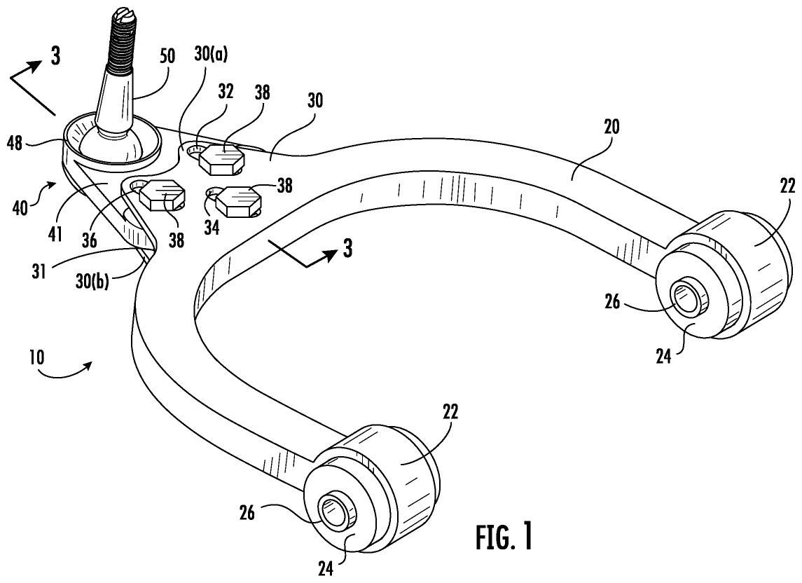

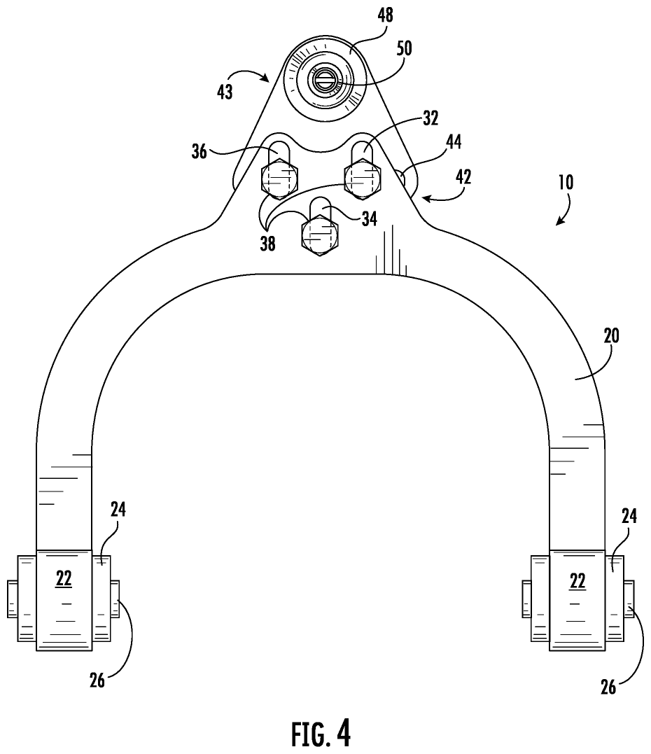

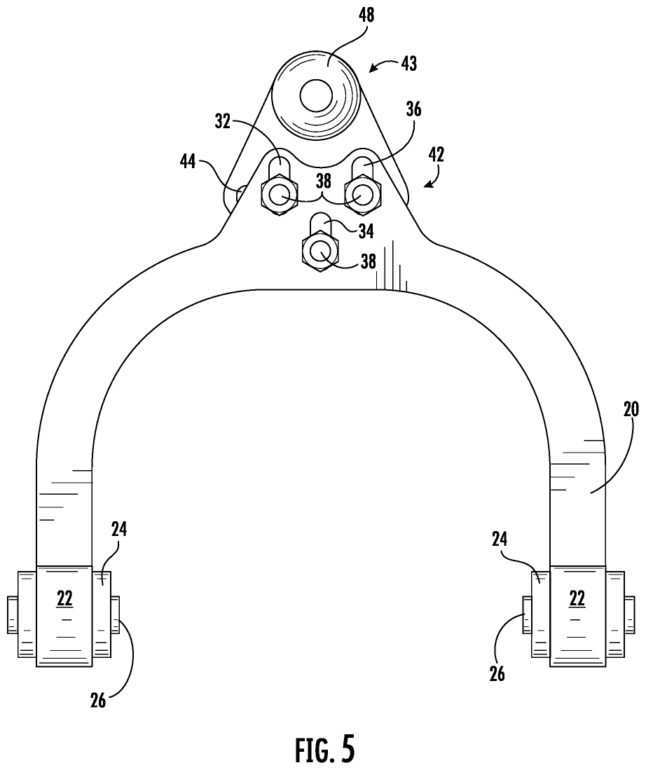

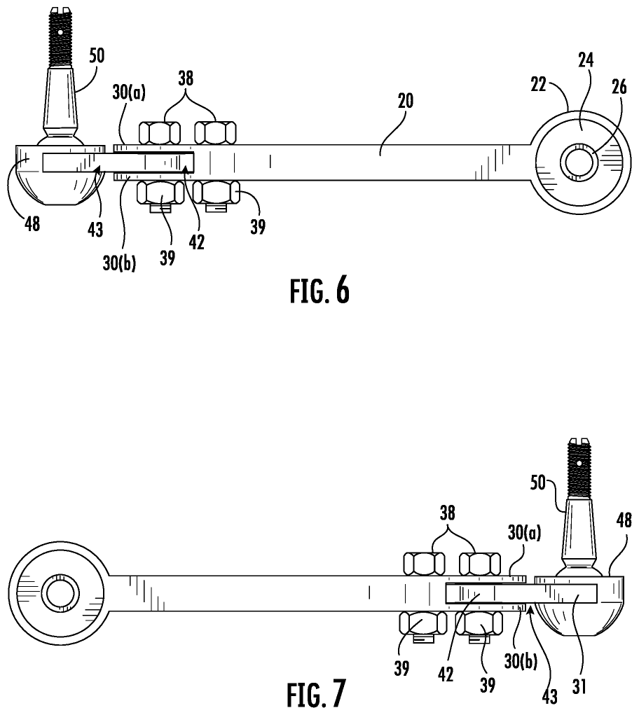

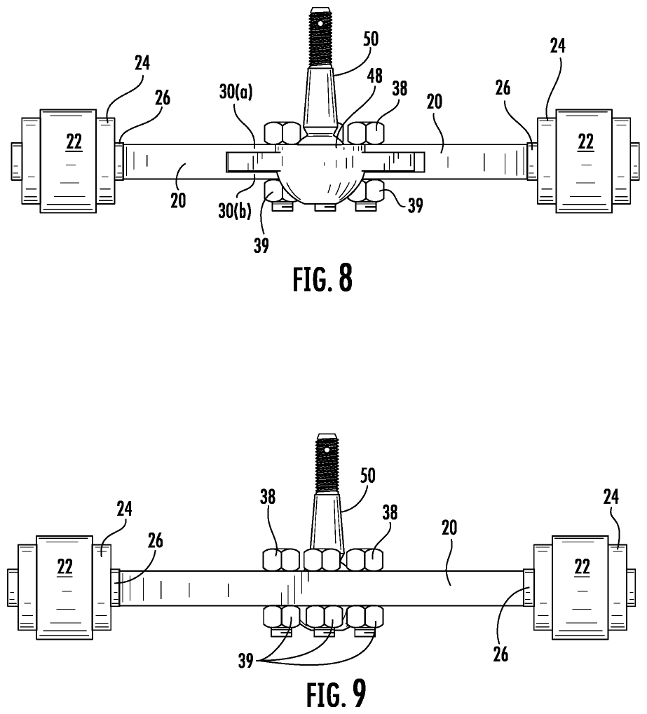

An adjustable control arm and ball joint assembly 10 is illustrated in FIGS. 1 through 9. The illustrated assembly 10 has a frame portion 20 and ball joint assembly 40. The frame 20 has mounting ends 22 that secure the frame 20 to a vehicle and a connecting arcuate or arched portion with a free end 30. Each end 22 is illustrated with a bushing 24 and steel sleeve 26; however, these components, end 22, bushing 24, and sleeve 26, may be varied according to the specific vehicle application.

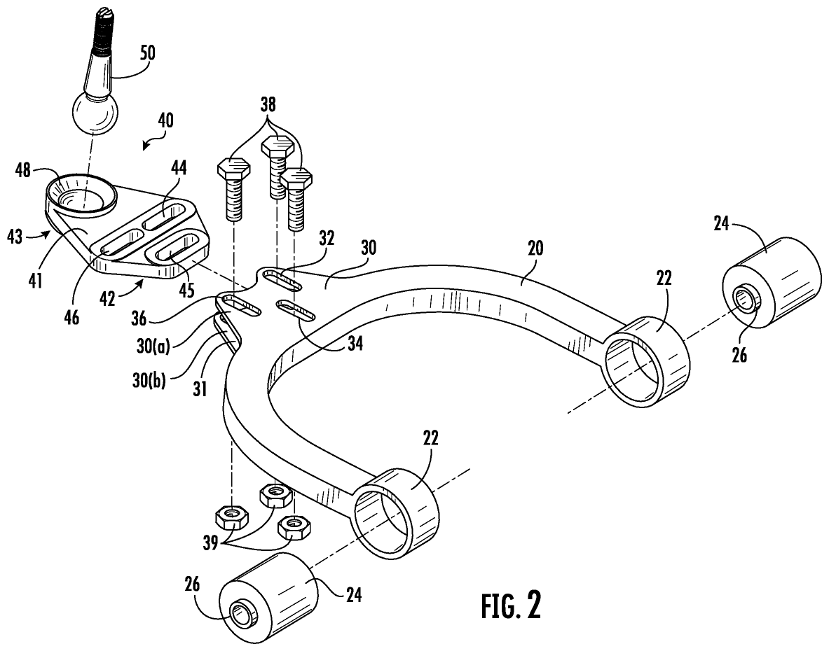

The free end 30 of the frame 20 has a plurality of slots 32, 34, and 36 for the passage of fasteners, such as bolts 38, which may be secured with nuts 39. The slots 32, 34, and 36 are shown here as elongated with a major axis oriented in a first direction and parallel sides. The free end 30 has upper and lower portions 30(a) and 30(b) that define a recess 31 for the ball joint assembly 40. The carrier 41 has a lead end 42 with slots 44, 45, and 46 which are also shown as elongated with parallel sides and a major axis oriented in a second direction that intersects the major axis of the slots 32, 34, and 36. As shown in FIG. 2, the major axes of slots 32, 34, and 36 are parallel to each other, but the slots are staggered or offset with respect to each other. Likewise, the major axes of slots 44, 45, and 46 are parallel to each other, but the slots are staggered or offset with respect to each other.

With reference to FIGS. 1 and 2, carrier 41 of the ball joint assembly 40 has a lead end 42 that is dimension to be received in the recess 31 formed by upper and lower portions 30(a) and 30(b) of the free end 30. The trailing end 43 of carrier 41 has a socket 48 and a ball joint 50. Socket 48 and ball joint 50 may vary according to the specific vehicle application.

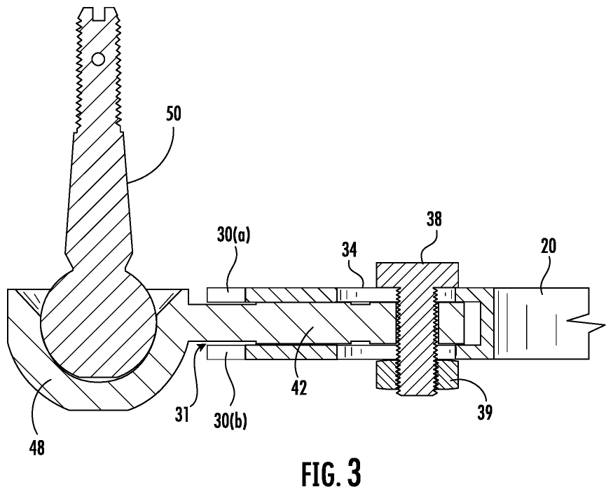

With reference to FIG. 3, it can be seen that lead end 42 of the carrier 41 can move along both major axes within the recess 31 of the free end 30. Thus, the position of carrier 41 is adjustable along the lengths of the major axes of slots 32, 34, and 36 and the lengths of major axes 44, 45, and 46 to a desired position where slots with a major axis oriented in a first direction are coincident with the slots having a major axis oriented in a second direction such that a fastener, such as bolt 38, passes through the slots and is tightened against the upper and lower portions 30(a) and 30(b) with a complementary component, such as nut 39.

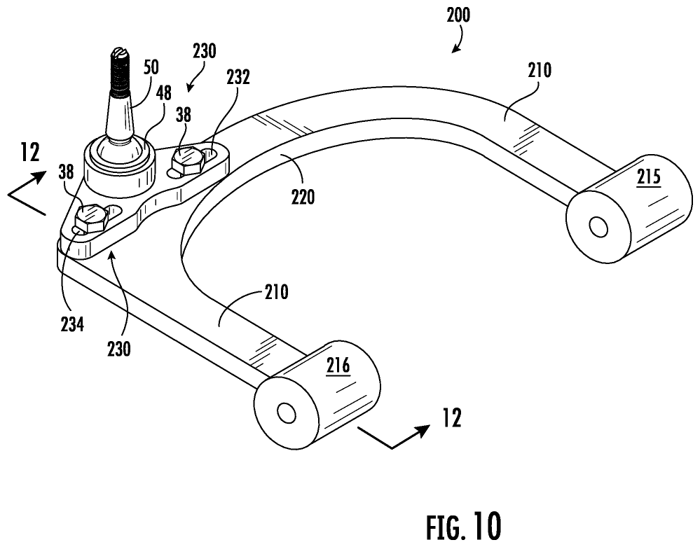

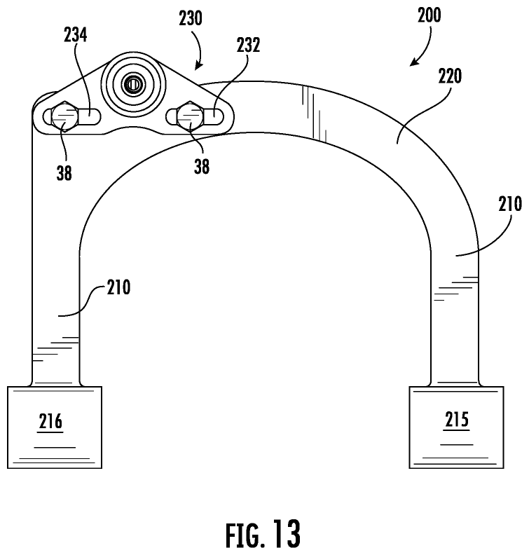

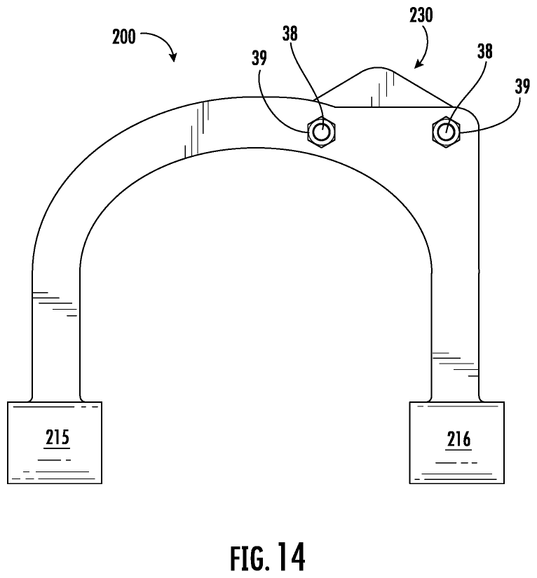

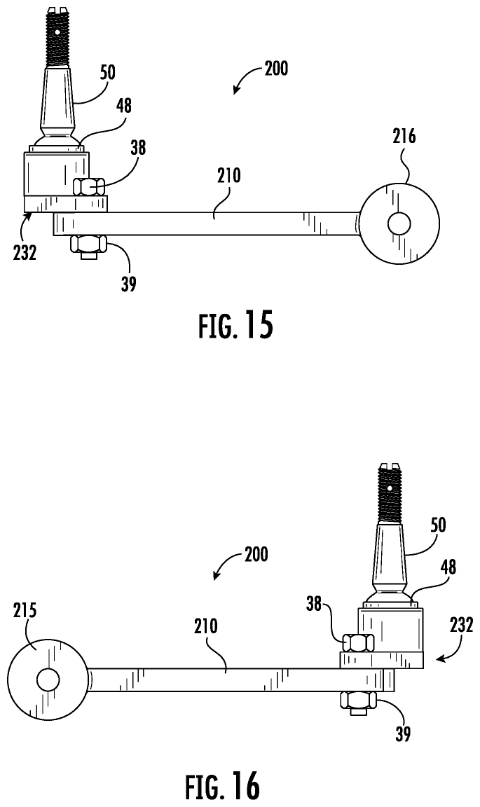

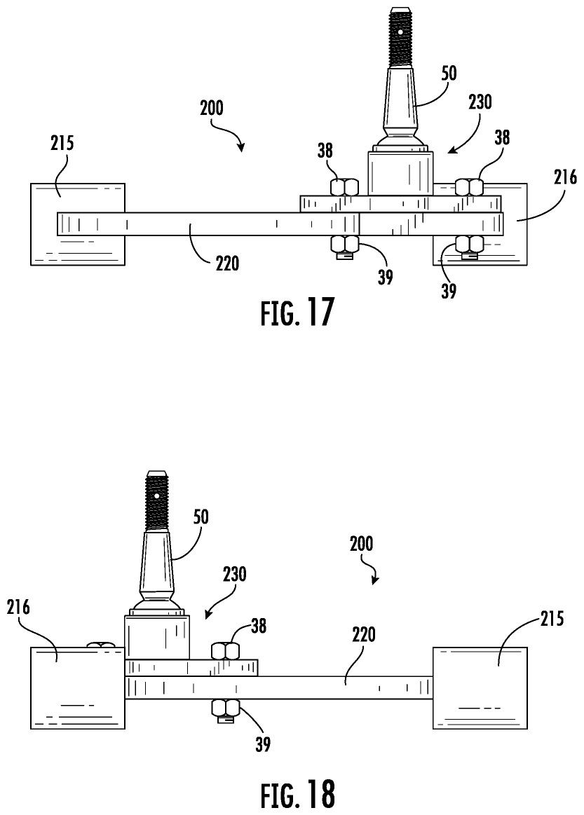

Another adjustable control arm and ball joint assembly 200 is illustrated in FIGS. 10 through 18. The illustrated assembly 200 has a frame portion 210 and ball joint assembly 230. The frame 200 has mounting ends 215 and 216 secure the frame 200 to a vehicle. The ends 215 and 216 are illustrated without a bushing or steel sleeve; as noted before, the ends 215 and 216 may vary according to the specific vehicle application.

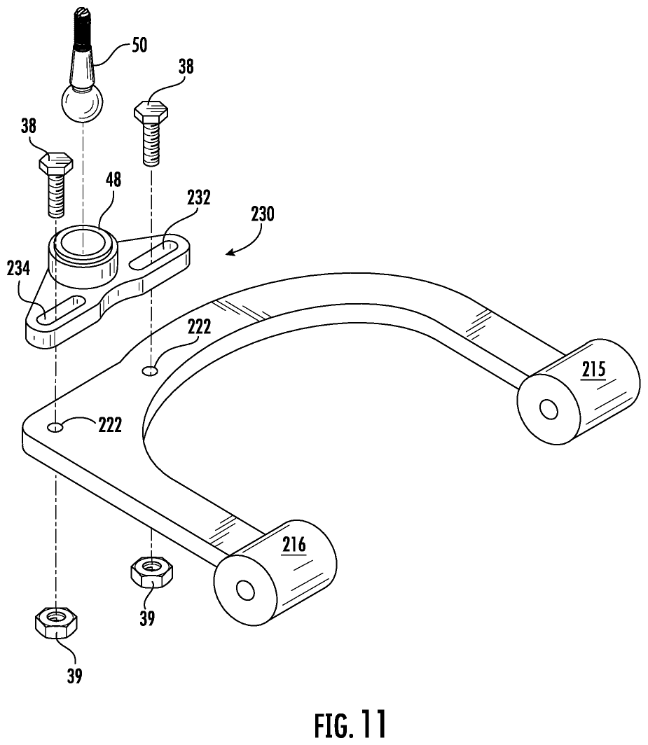

With reference to FIGS. 10 and 11, the frame of assembly 200 has extensions 210 that extend away from mounting ends 215 and 216 to an arcuate or arched portion 220. The arched portion 220 has a pair of through apertures 222 for fasteners, such as bolts 38, which may be secured with nuts 39. The ball joint carrier 230 has slots 232 and 234. The slots 232 and 234, as illustrated, are non-circular with a major axis, a minor axis, and parallel sides. The slots 232 and 234 are spaced to coincide with the spacing of apertures 222 and enable passage of the bolts 38. The assembly 230 includes a socket 48 and a ball joint 50. The position of carrier 230 can be adjusted along the major axis of slots 232 and 234 over the length of the slots 232 and 234 while incident with apertures 222 to allow bolts 38 to pass through.

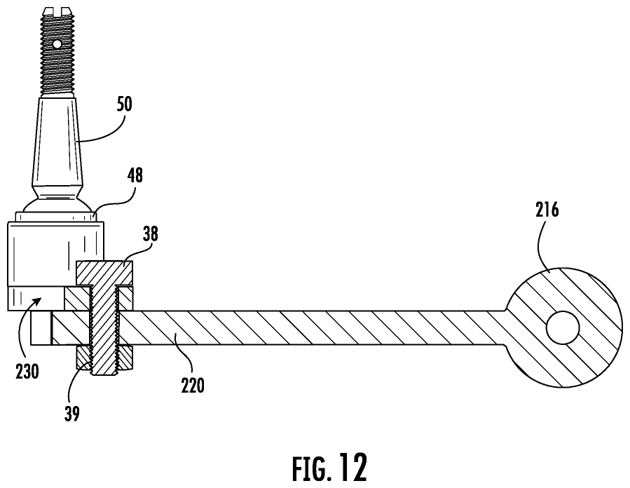

As illustrated in FIG. 12, the ball joint assembly 230 is mounted on the arcuate or arched portion 220 and fastened in place when the desired location for the ball joint is achieved. It will be understood from FIG. 12, that the ball joint assembly 230 may be mounted on the arcuate or arched portion 220 on the surface opposite to that illustrated in FIGS. 10 through 18.

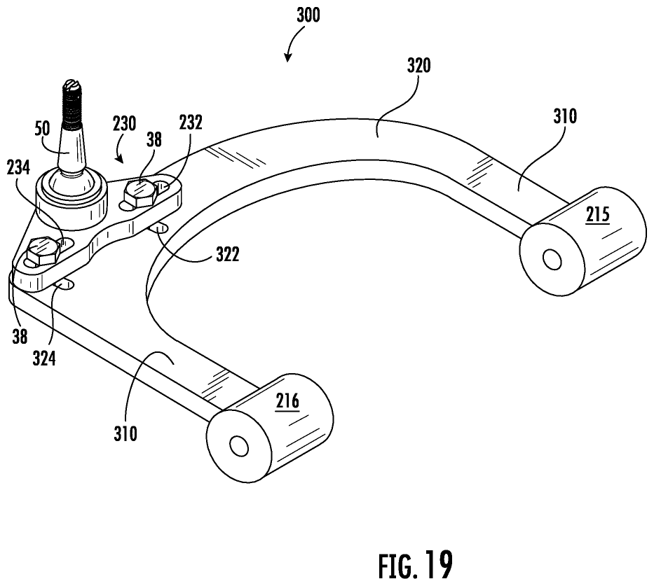

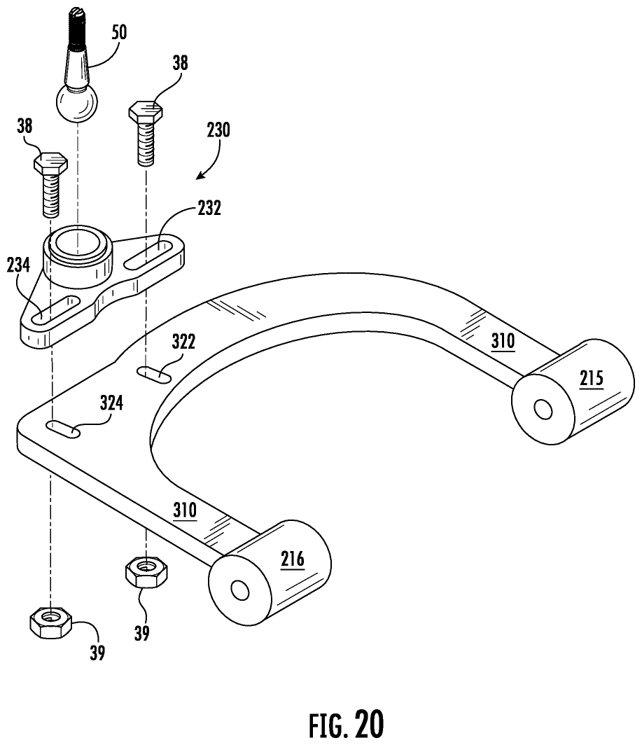

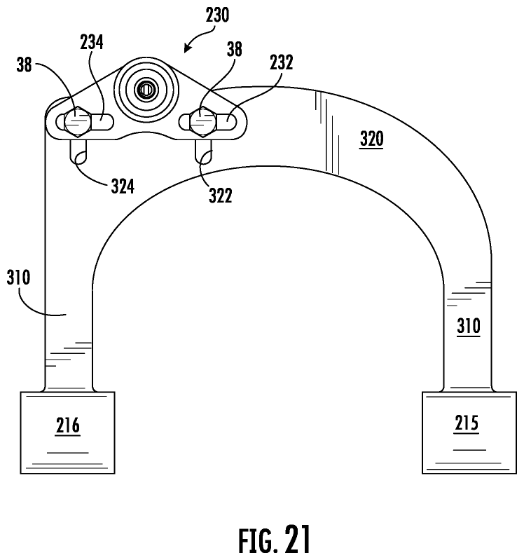

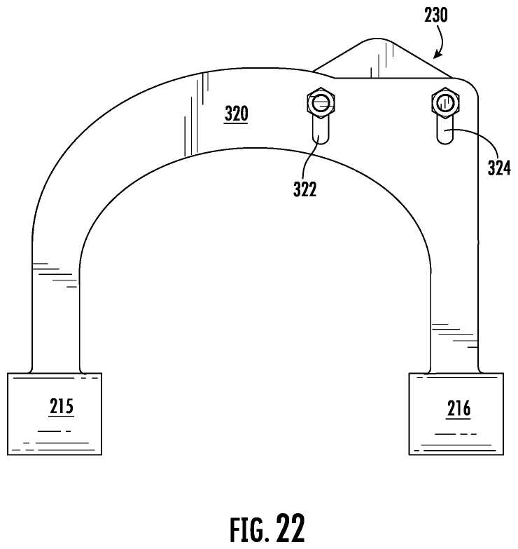

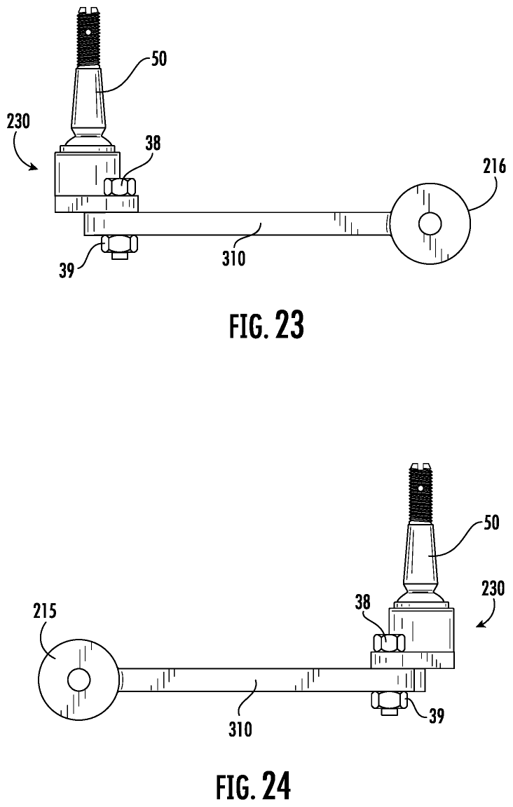

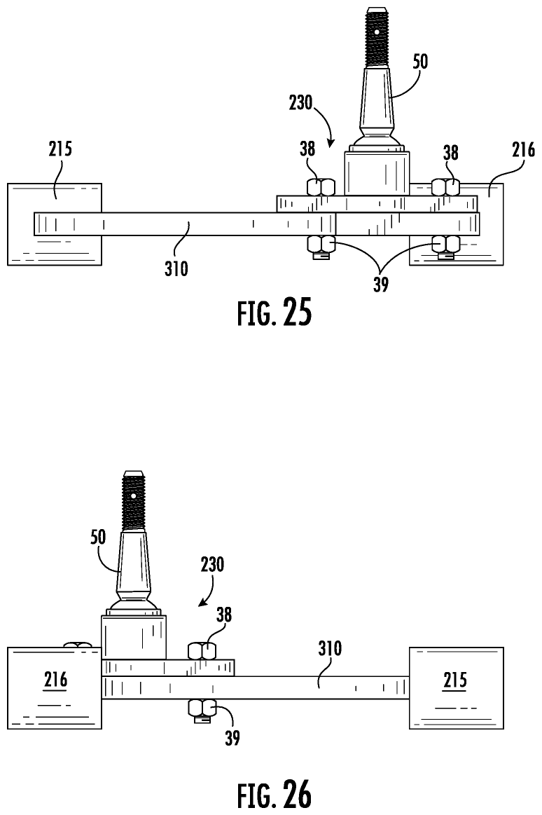

Another adjustable control arm and ball joint assembly 300 is illustrated in FIGS. 19 through 26. The assembly 300 has a frame portion 320 and a ball joint assembly 230 as described previously. The frame 320 has mounting ends 215 and 216, as described previously, to secure the frame 300 to a vehicle.

With reference to FIGS. 19 through 22, it can be seen that the frame of assembly 30 has extensions 310 that extend away from mounting ends 215 and 216 to an arcuate or arched portion 320. The arched portion 320 has a pair of slots 322 and 324 that intersect the slots 232 and 234 which align to receive fasteners. The ball joint carrier 230 is as previously described. This embodiment differs from the prior embodiment 200 illustrate in FIGS. 10-18 in that it permits adjustment in two directions as described in connection with the prior embodiment illustrated in FIGS. 1-9.

What is claimed is:

1. A vehicle suspension control arm comprising:
a first body having a first portion configured for mounting to a vehicle and a second portion that is configured to secure a ball joint assembly to the body;
the second portion includes a recess configured to receive at least a portion of a ball joint assembly and at least one slot with a first longitudinal axis intersects the recess; and,
a ball joint assembly that includes a ball joint mounted on a second body that has at least one slot with a second longitudinal axis that intersects the first longitudinal axis located at a portion of the second body that is configured to be received in the recess in the first body;
whereby the position of the ball joint relative to the vehicle is adjustable by positioning the at least one slot with a first longitudinal axis relative to the at least one slot with a second longitudinal axis.

2. A vehicle control arm comprising:
a frame having a first end that mounts to a vehicle and a second end that is configured to secure a ball joint assembly to the frame;
the second end includes at least one longitudinal slot in a designated area for securing a ball joint assembly; and,
a ball joint assembly that configured to be secured in the designated area and includes at least one longitudinal slot that is positioned to coincide with the at least one longitudinal slot in the second end;
whereby the position of the ball joint assembly relative to the frame is adjusted by positioning the at least one longitudinal slot in the second end of the frame relative to the at least one longitudinal slot in the ball joint assembly.

3. The vehicle control arm of claim 2, wherein the second end of the frame has at least two longitudinal slots.

4. The vehicle control arm of claim 2, wherein the ball joint assembly has at least two longitudinal slots.

5. The vehicle control arm of claim 2, wherein the second end of the frame has at least two longitudinal slots and the ball joint assembly has at least two longitudinal slots.

6. The vehicle control arm of claim 2, wherein the second end of the frame has at least three longitudinal slots.

7. The vehicle control arm of claim 6, wherein the ball joint assembly has at least two longitudinal slots.

8. The vehicle control arm of claim 7, wherein the at least three longitudinal slots in the second end of the frame have a first longitudinal axis and the at least two longitudinal slots in the ball joint assembly have a second longitudinal axis that intersects the first longitudinal axis through the at least three longitudinal slots in the second end of the frame.

9. The vehicle control arm of claim 7, wherein the at least three longitudinal slots in the second end of the frame are parallel to each other and the at least two longitudinal slots in the ball joint assembly intersect the at least three longitudinal slots in the second end of the frame.

10. The vehicle control arm of claim 7, wherein the at least two longitudinal slots in the ball joint assembly are parallel to each other.

11. The vehicle control arm of claim 2, wherein a recess in the second end is dimensioned to receive the ball joint assembly.

12. The vehicle control arm of claim 11, wherein the ball joint assembly is positioned within the recess in the second end with the at least one longitudinal slot in the ball joint assembly having a longitudinal axis that is perpendicular to a longitudinal axis through the at least one longitudinal slot in the second end of the frame.

13. The vehicle control arm of claim 2, wherein the at least one longitudinal slot in the second end has parallel sides.

14. The vehicle control arm of claim 2, wherein the at least one longitudinal slot in the ball joint assembly has parallel sides.

15. The vehicle control arm of claim 2, wherein the at least one longitudinal slot in the second end has parallel sides and the at least one longitudinal slot in the ball joint assembly has parallel sides.

16. An adjustable control arm comprising:
a control arm with first end, designated for mounting to a vehicle, and at a second end, designated for securing a ball joint assembly to the control arm, that, includes at least one through aperture for passage of a fastener; and,
a ball joint assembly that is dimensioned for connecting with the control arm and includes at least one aperture for passage of a fastener that is positioned to receive a fastener passed through the at least one through aperture in the second end;
whereby the ball joint assembly is secured to the control arm in a desired location by positioning a fastener passed through the at least one aperture in the second end and the at least one aperture in the ball joint assembly.

17. A vehicle control arm comprising:
a frame having a first end that mounts to a vehicle and a second end that is configured to secure a ball joint assembly to the frame;
the second end includes a slot that is elongated in a first direction and located in a designated area for securing a ball joint assembly; and,
a ball joint assembly that configured to be secured in the designated area and includes a slot that elongated in a second direction and is positioned to coincide with the elongated slot in the second end;
whereby the position of the ball joint assembly relative to the frame is adjusted by positioning the elongated slot in the second end of the frame relative to the elongated slot in the ball joint assembly.

18. The vehicle control arm of claim 17, wherein the elongated slot in the second end of the frame has parallel sides.

19. The vehicle control arm of claim 17, wherein the elongated slot in the ball joint assembly has parallel sides.

20. The vehicle control arm of claim 17, wherein the elongated slot in the second end of the frame has parallel sides and the elongated slot in the ball joint assembly has parallel sides.

21. A vehicle control arm comprising:
a frame that mounts to a vehicle and has free end configured to secure a suspension assembly to the frame;
the free end includes a slot that has a major axis in a first direction and located in a designated area for securing a suspension assembly; and,
a suspension assembly that is configured to be secured in the designated area of the free end and includes a slot that has a major axis in a second different direction;
whereby the position of the suspension assembly relative to the frame is adjusted by positioning the major axis of the slot in the free end in a first direction relative to the major axis of the slot in the suspension assembly in a second different direction.

22. A control arm comprising:
a frame having a first portion that mounts to a vehicle and a second portion that includes at least two through apertures for securing a suspension assembly to the frame; and,
a suspension assembly that includes at least two apertures for securing the suspension assembly to the frame at the at least two through apertures of the frame;
whereby the position of the suspension assembly on the frame is adjusted by positioning the at least two apertures of the suspension assembly relative to the at least two through apertures of the frame.

23. The control arm of claim 22, wherein the at least two apertures of the suspension assembly are non-circular.

24. The control arm of claim 22, wherein the at least two apertures of the suspension assembly are elongated with a major axis and a minor axis.

25. A control arm comprising:
a frame having a first portion that mounts to a vehicle and a second portion that includes a plurality of elongated slots having a major axis in a first direction for securing a suspension assembly to the frame; and,
a suspension assembly that includes a plurality of elongated slots having a major axis in a second direction for securing the suspension assembly to the frame;
whereby the suspension assembly is adjustably positioned on the frame by locating the plurality of elongated slots having a major axis in a first direction so they intersect the plurality of elongated slots having a major axis in a second direction.

26. The control arm of claim 25, wherein the second portion includes at least three elongated slots having a major axis in the first direction.

27. The control arm of claim 25, wherein the suspension assembly includes at least three elongated slots having a major axis in the second direction.

28. The control arm of claim 25, wherein the second portion includes at least three elongated slots having a major axis in the first direction and the suspension assembly includes at least three elongated slots having a major axis in the second direction.

29. The control arm of claim 28, wherein the major axes of the at least three elongated slots having a major axis in the first direction are parallel to each other while the at least three elongated slots are staggered relative to each other, and the major axes of the at least three elongated slots having a major axis in the second direction are parallel to each other while the at least three elongated slots are staggered relative to each other.
